(19) United States
(12) Patent Application Publication
(10) Pub. No.: US 2007/0198299 A1
(43) Pub. Date: Aug. 23, 2007

(54) Method for Identifying Minority Health Factor Disparities Within Geographic Zones

(76) Inventor: Gary Puckrein, Washington, DC (US)

Correspondence Address: KILE GOEKJIAN REED & MCMANUS, 1200 NEW HAMPSHIRE AVE, NW, SUITE 570, WASHINGTON, DC, 20036, US

(21) Appl. No.: 11/676,881

(22) Filed: Feb. 20, 2007

Related U.S. Application Data
(60) Provisional application No. 60/774,377, filed on Feb. 17, 2006.

(51) Int. Cl. G06Q 10/00; G06F 19/00

(52) U.S. Cl. 705/2; 702/19

(57) ABSTRACT

A method for identifying minority health factor disparities within a first geographic zones, such as a state boundary of the United States, including the steps of determining the per cent prevalence of a health factor, for example diabetes, within the first geographic zone, identifying minority demographic group sub-zones within the first geographic zone, determining the per cent prevalence of the health factor of the minority demographic group within the first geographic zone, computing the per cent prevalence of health factor by minority demographic group within the geographic sub-zone and mapping within the first geographic zone the prevalence of the health factor within the minority demographic group sub-zones.

### RELATED PATENTS

This application relates to and claims the priority benefit of applicant's Provisional Application Ser. No. 60/774,377 filed on Feb. 17, 2006 and entitled “Health Disparity Information System.” The disclosure of this Provisional Application is hereby incorporated by reference as though set forth at length.

### BACKGROUND OF THE INVENTION

This invention relates to a method for identifying disparities in health factors among minority groups by geographic sub-zones. More specifically this invention relates to identifying such health disparity sub-zones based on subsets of information involving health factor, age, gender, and ethnicity and mapping the information within geographically relevant coordinates.

Certain health data on prevalence or incidence of diseases and other health factors is available in the United States on a local level. An example is that the National Institutes of Health maintain kidney disorder data by zip codes. Other such data is available, if at all, on a state by state basis. An example of the latter is that the National Center for Disease Control maintains a state-based system of health surveys that collects information on health risk behaviors, preventive health practices, and health care access primarily related to chronic disease and injury. This system is the Behavioral Risk Factor Assessment System (BRFSS). For many states, the BRFSS is the only available source of timely, accurate data on health-related behaviors, including but not limited to alcohol consumption, arthritis, asthma, cardiovascular disease, cholesterol awareness, diabetes, exercise, healthcare availability and utilization, immunization, prostate cancer, weight control and others. Finally, some data is in the hands of governmental agencies and, perhaps, private parties, but is not available to the general public.

Such data is generally considered useful by many sectors involved in health care and concerned in identifying emerging health problems, establishing and tracking health objectives, and developing and evaluateing public health policies and programs, particularly as relates to minority groups. Many states also use BRFSS data to support health-related legislative efforts.

The utility of state by state health based data would be enhanced if itwere identified on a local basis, such as zip codes, congressional or legislative districts, counties, and the like. Such sub-state information would be of interest to health care providers, legislators at local, state and nation levels, pharmaceutical companies, manufacturers of medical devices, researchers, and others.

Heretofore, there has been no method or procedure for conveniently identifying sub-state level information from existing health care and other data. The objective of the current invention has been to estimate reasonably accurate sub-state level health data using national census and other population description data in combination with BRFSS or other information maintained on a state by state basis and including population diversity or descriptive factors.

The problems suggested in the preceding are not intended to be exhaustive but rather are among many which may tend to reduce the effectiveness of methods for determining minority health disparity within geographic zones. Other noteworthy problems may also exist; however, those presented above should be sufficient to demonstrate that methods for identifying minority health factor disparities within geographic zones will admit to worthwhile improvement.

### SUMMARY OF THE INVENTION

One embodiment of the invention comprises a method for identifying minority health factor disparities within first geographic zones, such as state boundaries of the United States, including the steps of determining the percent prevalence of a health factor, for example diabetes, within a state boundary, identifying sub-zones within a state, such as for example zip code designations, determining the per cent prevalence of a health factor of the minority demographic group within the first geographic zone, computing the per cent prevalence of the health factor, by minority demographic group, within the geographic sub-zone and mapping within the first geographic zone the prevalence of the health factor within the minority demographic group sub-zones, such as by zip codes.

### THE DRAWINGS

Other aspects of the present invention will become apparent from the following detailed description of embodiments taken in conjunction with the accompanying drawings wherein:

FIG. 1 is a flow chart illustrating a general sequence of the subject method for identifying minority health disparities within a geographic zone;

FIG. 2 is a more detailed flow chart illustrating a sequence in accordance with one embodiment of the invention relating to identifying and mapping minority health disparity with respect to instances of one health factor—diabetes;

FIG. 3 is a map of the District of Columbia indicating the minority health disparity by zip code for the prevalence of diabetes;

FIG. 4 is a map of the northern half of the state of Mississippi reflecting a minority health disparity by zip code for the prevalence of diabetes;

FIG. 5 is a map similar to the map of FIG. 4 for the southern half of Mississippi; and

FIG. 6 is a comparison map of the state of Oregon indicating that there are no minority zones by zip code within the state of Oregon.

### DETAILED DESCRIPTION

### Context of the Invention

Turning now to the drawings the subject invention is directed to the concept of identifying minority health factor disparities within geographic zones such as zip codes, counties, Congressional districts within a state, state legislative boundaries, etc.

Although census and statewide health factor information can be determined from various reporting services and organizations within and outside of the government little has been available to date with respect to health factor issues most affecting minorities such as African-American and Hispanics within sub-zones such as by zip codes. In addition within those minority groups are the notions of gender differentiation and, in addition, age factors such as an age differential of a first group of ages between 18 to 49, a second group of ages between 50 and 64 and a third group 65 and above.

As used in this patent the expression minority prevalence within a geographic zone will mean any geographic zone where the percent of non-whites is greater that fifty percent. This definition may also be sub-divided into African-American, Hispanic and all other non-whites

Although health factor information in the categories identified above on a zip code level of geographic significance would be useful information for health care providers, pharmaceutical companies, governmental bodies, insurance companies, etc., little information is publicly available at such a micro geographic level for minority health factors. As used in this patent, the term health factor or factors will mean any of the categories identified in the International Classification of Diseases, Ninth Edition, Clinical Modification (ICD-9-CM) which is based on the World Health Organization's Ninth Revision, International Classification of Diseases (ICD-9). Moreover, as used in this patent the term health factors includes risk factors and specific diseases. A “risk factor” is any physical or behavioral trait that correlates to a disease. It is a broader term than disease. For example, risk factors for a heart attack are: high blood pressure, high fat diet, high cholesterol, etc. Note that some risk factors are physical, such as high blood pressure, while some are purely behavioral, such as smoking.

Although the subject invention is broad enough to include all diseases and risk factors there are six that are of particular interest to minorities such as African-Americans—diabetes, cancer, renal health factors, hypertension, asthma and coronary heath factors.

### Method for Monitoring Minority Health Factor Disparities

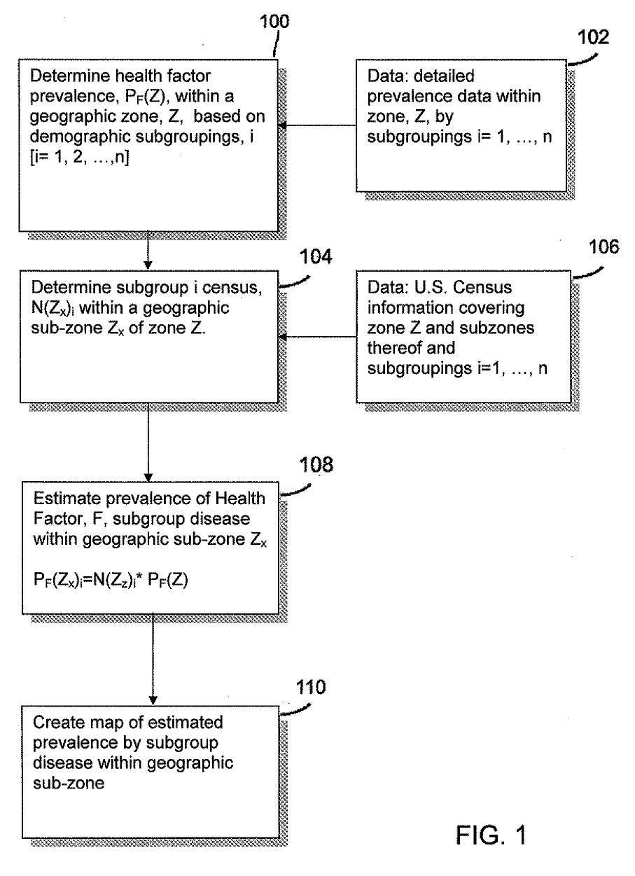

FIG. 1 illustrates a generalized flow chart for identifying disparities in health factors among minority groups by geographic sub-zones. In step 100, the prevalence per cent, P_{F}(Z), of a given health factor, F, is determined for a geographic zone, Z, based upon desired demographic sub-groupings. Such sub-groupings may consist of unique demographic characteristics, such as gender, age groups, or ethnicity, or combinations of one or more sub-groupings of unique demographic characteristics. The method may be applied to one specific demographic characteristic (for example: males), a specific category within a subgroup (for example: all persons from age 18 to 49), or combinations of one or more of the sub-groupings. Note that the number of combinations depend upon the number of sub-groupings and categories within sub-groupings. Using the example of sub-groupings of gender, age groups and ethnicity, and assuming that gender has two categories (male and female), age groups have three categories (18-49, 50-64, and 65 and above) and ethnicity has four categories (black non-Hispanic, black Hispanic, non-black, all other), there are 24 possible combinations (given by 2×3×4). Each such combination may be numbered for descriptive purposes from i=1, 2, 3, . . . , 24. A source of detailed prevalence data (102) applicable to zone Z must be available and such data must contain prevalence broken down by sub-groupings of interest, such that the desired unique sub-groupings or combinations, i=1, 2, 3, . . . , n, each have an associated prevalence percentages of the health factor, F, of interest.

In step 104, a source of population census data, 106, (normally, United States Census information) is used to provide the census of each sub-zone within zone Z. Such census is determined for each of the sub-groupings or combinations, i=1, 2, 3, . . . , n, in terms of number of persons, or, N(Zₓ)ᵢ, where the notation stands for the number of persons within sub-zone x of zone Z corresponding to the demographic i. The sum of all N(Zₓ)ᵢ totals the number of all persons corresponding to the demographic i, or

$${\sum }_{i = 1}^{n} {N ( {Z}_{x} )}_{i} = {N ( {Z}_{TOT} )}_{i}$$

In step 108, a statistical synthetic prevalence within each sub-zone x of health factor F is estimated from the relationship, P_{F}(Zₓ)i=N(Zₓ)ᵢ*P_{F}(Z)i. The result of step 108, may be thought of as a two-dimensional array of the prevalence percentages of the demographic subgroups or combinations within each of the sub-zones of the geographical zone of interest.

In step 110, the two-dimensional array determined in the immediately prior step is mapped within the geographical boundaries of zone Z. Sub-zone boundaries are reflected within the map, and the prevalence percentages are shown for one or more of the demographic subgroups or combinations by the use of distinguishing colors or other markings consistent with graphical and/or, mapping techniques commonly used.

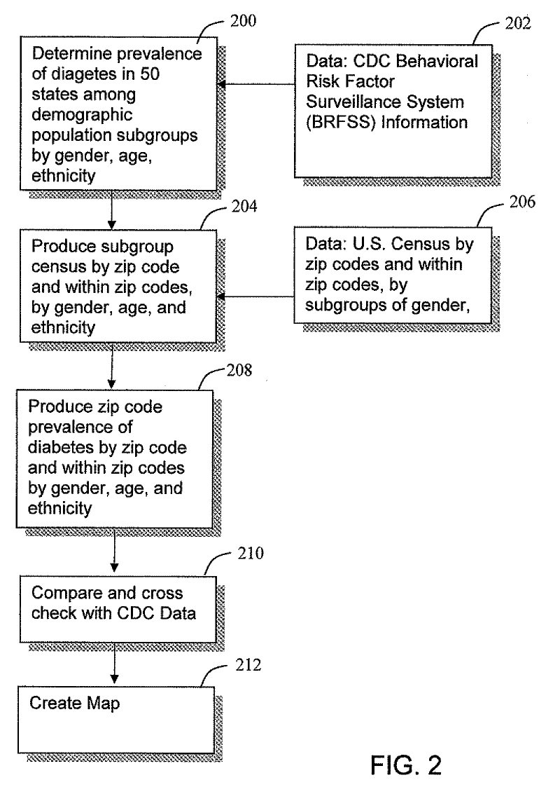

A specific example of a useful application of the invention is set forth in the flow chart shown in FIG. 2. In this example, the desired aim or use of the invention is to identify the health disparities in the prevalence of diabetes in minority populations within individual ones of the 50 states. Such disparities are to be identified at the level of zip codes within each state. Furthermore, minority populations are to be considered on the basis of gender (male and female), and age groups in years (18-49, 50-64, 65 and above). Minority demographic definition is based on ethnicity. Ethnicity is determined from the ethnic groupings of white non-Hispanic, black non-Hispanic, Hispanic and all others. A minority zip code for these purposes is a zip code in which the total of the last three stated groupings exceed 50% of the total population of the zip code. In step 200, using data, 202, maintained by the Center for Disease Control (CDC) under its Behavioral Risk Factor Surveillance System (BRFSS), the prevalence of diabetes for each state is determined, broken down by the gender, age and ethnicity groups. Such breakdowns are available within the BRFSS format. Using United States census data, 206, which is itself available broken down by zip code and, within each zip code, by the gender, age, ethnicity subgroups of interest, the census of such subgroups are determined for each zip code within each state, step 204. In step 208, the zip code prevalence of diabetes is determined by multiplying the population within each zip code by the statewide prevalence of diabetes for each of the subgroups of interest determined in step 200. Step 208 results in an array of the data of interest. Such data is compared and checked (step 210) against the CDC and census data by standard statistical methods to assure its accuracy and completeness. The existence of disparities of diabetes prevalence is identified by mapping (step 212) the data in the form of conventional maps of the states and their included zip codes, using customary mapping and graphical techniques.

While the foregoing specific example is of utility in formulating health policy, determining commercial or medical steps to attack and reduce minority disparities in treating diabetes or seeking its reduction, it should be noted that the selection of diabetes as the example of the health factor and the use of zip codes as sub-zones is not limiting. Other health factors, such as behavior activities, other diseases and other conditions are maintained in by CDC in its BRFSS; moreover, other sub-zones, such as counties, state legislative districts and Federal congressional districts cane be selected sub-zones within the states for which minority disparities based on each ethnic group of interest may be significant.

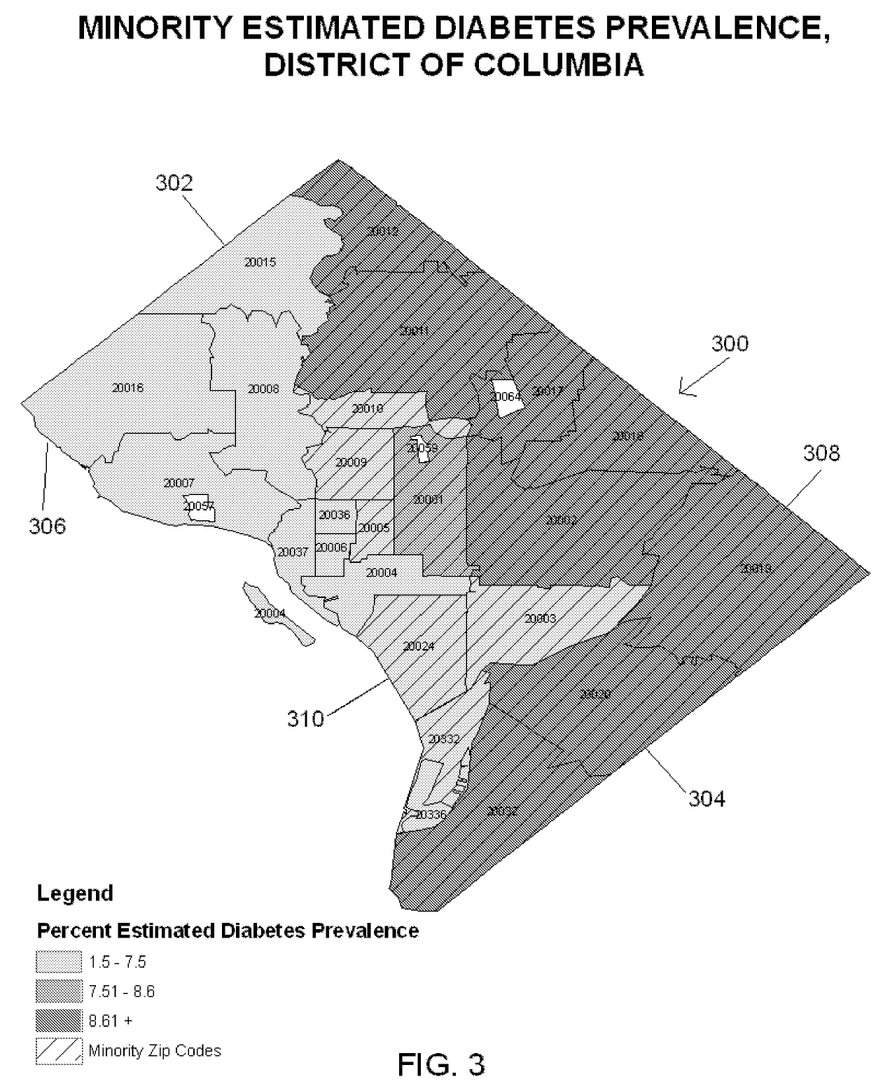

Referring now to FIG. 3 a geographic map of the District of Columbia 300 is shown with zip code geographic zones, such that zone 302 is zip code 20015 and zone 304 is zip code 20020 on the map 300.

As the legend indicates also superimposed on the map by zip code in three shades of grey are estimated percentages of diabetes prevalence. As an example, in zone 306, that corresponds to zip code 20018, the prevalence of diabetes is estimated to be between 1.5 and 7.5 percent. In a similar manner looking at geographic zip code zone 308, which is zone 20018, the estimated percentage of diabetes prevalence is 8.61 percent or greater and referring to zone 310, which is zip code 20024 the prevalence of diabetes is 7.51 to 8.6 percent.

In addition to the zip code zones and the diabetes prevalence information, the map 300 also carries superimposed cross-hatching which by the legend indicates those zip codes where minorities reside. In this connection, and as stated above, a minority zip code zone corresponds to a geographic zip code zone where the population is greater that fifty percent non-white.

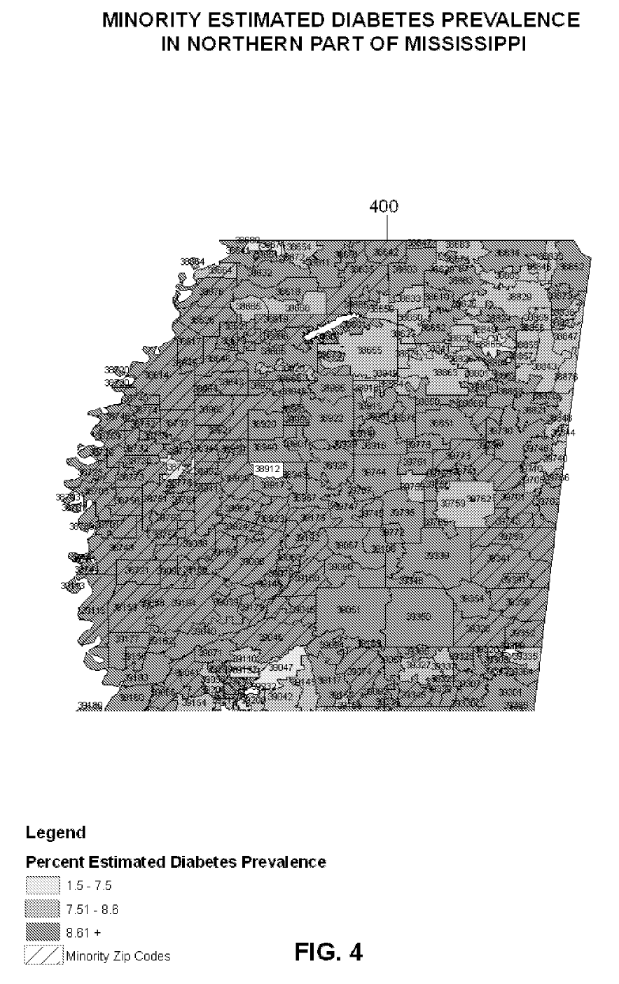

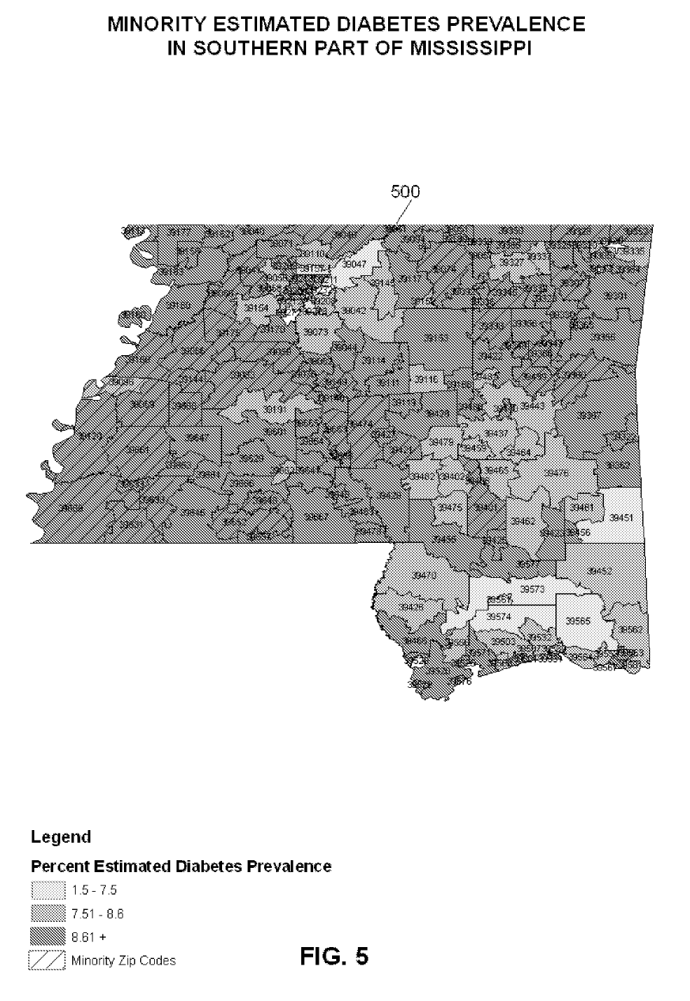

FIGS. 4 and 5 in combination disclose another state of the United States—Mississippi. FIG. 4 is the northern part of the state 400 and FIG. 5 discloses a southern part of the state 500. The state of Mississippi is divided in these maps into geographic zip code zones and the legend designations for FIGS. 4 and 5 are identical with the legend designations for FIG. 3. In this, there are grey shading to indicate estimated percentage prevalence of diabetes in zones by zip code of 1.5 to 7.5 percent, 7.51 to 8.6 percent, and greater that 8.61 percent. Finally the legend also indicates that minority zip codes are also cross hatched on the FIGS. 4 and 5. Accordingly it is possible to conveniently determine the prevalence of diabetes by minority zip codes within the state and comparison with zip code geographic regions that are non-minority.

In addition to identifying individual minority zones by zip code or other micro geographic designation, it is of interest to health care providers, insurance companies, legislative planners and others to identify two or more contiguous zip codes for minorities with a high incidence of health factor issues so that resources can be efficiently allocated and remediation properly addressed. In this connection, by application of the subject invention it is possible to quickly identify minority health disparity zones within a state and within the United States. When two or more contiguous sub-zones, such a zip codes, are identified as having a high incidence of a health factor that region can be compared with the average frequency of that health factor in the country as a whole. An evaluation can then be made to determine if that sub-zone is a region with substandard health care in accordance with generally accepted guidelines. Once there is a determine of both high incidence of a health factor and substandard care within health disparity zones health care provider services can be alerted so that health care providers and planners can remediate the problem with cost effective intervention.

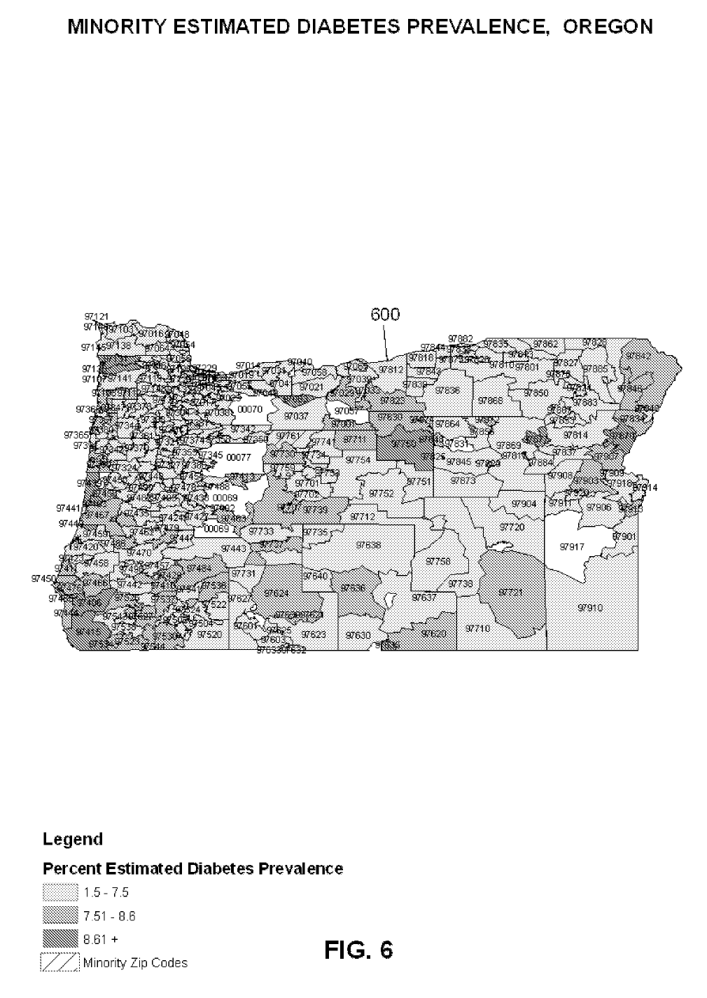

Turning now to FIG. 6, and for comparison with the District of Columbia and the state of Mississippi, there is shown a map of the state of Oregon with zip code geographic designations superimposed and a legend that is identical with the legend of FIGS. 3-5. What is interesting for comparison purposes is that there are no minority zip code geographic zones within the state of Oregon with health factor issues and therefore that state is not within the realm of interest of this invention at the present time.

The various aspects of the invention were chosen and described in order to best explain principles of the invention and its practical applications. The preceding description is intended to enable others skilled in the art to best utilize the invention in various embodiments and aspects and with various modifications as are suited to the particular use contemplated. It is intended that the scope of the invention be defined by the following claims; however, it is not intended that any order be presumed by the sequence of steps recited in the method claims unless an order is specifically recited.

What is claimed is:

1. A method for identifying minority health factor disparities within geographic zones comprising the steps of:
determining the per cent prevalence of a health factor within a first geographic zone for a minority demographic group;
identifying minority demographic group sub-zones within said first geographic zone;
if one or more minority demographic group sub-zones exist within the first geographic zone, determining the per cent prevalence of the health factor of said minority demographic group within said first geographic zone;
multiplying the prevalence of said minority demographic group by said per cent prevalence within the first geographic zone to determine by estimation the per cent prevalence of the health factor by minority demographic group within said geographic sub-zone; and
mapping within said first geographic zone at least the minority geographic group sub-zones with an indication of the prevalence of the health factor within the minority demographic group sub-zone.

2. A method for identifying minority health factor disparities within geographic zones as defined in claim 1, wherein:
said first geographic zone comprises the geographic boundary of a state of the United States; and
said second, geographic sub-zone within the boundary of a state of the United States comprises a zip code geographic zone.

3. A method for identifying minority health factor disparities within geographic zones as defined in claim 1, wherein:
said first geographic zone comprises the geographic boundary of a state of the United States; and
said second, geographic sub-zone within the boundary of a state of the United States comprises a legislative district within the state of the United States.

4. A method for identifying minority health factor disparities within geographic zones as defined in claim 1, wherein:
said first geographic zone comprises the geographic boundary of a state of the United States; and
said second, geographic, minority, sub-zone within the boundary of a state of the United States comprises a county within the state of the United States.

5. A method for identifying minority health factor disparities within geographic zones as defined in claim 1 wherein:
said minority demographic group comprises a subgroup where greater than fifty percent of the subgroup are African American.

6. A method for identifying minority health factor disparities within geographic zones as defined in claim 1 wherein:
said minority demographic group comprises a subgroup where greater than fifty percent are Hispanic.

7. A method for identifying minority health factor disparities within geographic zones as defined in claim 1 wherein:
said minority demographic group comprises age based subgroups of three categories of eighteen years of age to forty nine years of age as one subgroup and fifty years of age to sixty four years of age as a second subgroup and sixty five years of age and above as a third subgroup.

8. A method for identifying minority health factor disparities within geographic zones as defined in claim 1 wherein:
said minority demographic group includes a subgroup of two based on gender.

9. A method for identifying minority health factor disparities within geographic zones as defined in claim 1 wherein said step of determining the per cent prevalence of a health factor within a first geographic zone for a demographic subgroup comprises:
determining the percent prevalence of diabetes health factor within the first geographic zone.

10. A method for identifying minority health factor disparities within geographic zones as defined in claim 1 wherein said step of determining the per cent prevalence of a health factor within a first geographic zone for a demographic subgroup comprises:
determining the percent prevalence of renal health factor within the first geographic zone.

11. A method for identifying minority health factor disparities within geographic zones as defined in claim 1 wherein said step of determining the per cent prevalence of a health factor within a first geographic zone for a demographic subgroup comprises:
determining the percent prevalence of hypertension health factor within the first geographic zone.

12. A method for identifying minority health factor disparities within geographic zones as defined in claim 1 wherein said step of determining the per cent prevalence of a health factor within a first geographic zone for a demographic subgroup comprises:
determining the percent prevalence of cancer health factor within the first geographic zone.

13. A method for identifying minority health factor disparities within geographic zones as defined in claim 1 wherein said step of determining the per cent prevalence of a health factor within a first geographic zone for a demographic subgroup comprises:
determining the percent prevalence of heart health factor within the first geographic zone.

14. A method for identifying minority health factor disparities within geographic zones as defined in claim 1 wherein said step of determining the per cent prevalence of a health factor within a first geographic zone for a demographic subgroup comprises:
determining the percent prevalence of asthma health factor within the first geographic zone.

15. A method for identifying minority health factor disparities within geographic zones comprising the steps of:
determining the per cent prevalence of a health factor within a state of the United States for a minority demographic group;
identifying minority demographic group zones by zip code within said state;
determining the per cent prevalence of the health factor of said minority demographic group within the state as a whole;
multiplying the prevalence of said minority demographic group by the per cent prevalence within the state to determine by estimation the per cent prevalence of the health factor by minority demographic group within zip codes within the state; and
mapping within the state all zip code zones and identifying all zip code zones within the state with a minority demographic and indicating the prevalence of the health factor within the minority demographic group zip code.

16. A method for identifying minority health factor disparities within geographic zones as defined in claim 15 wherein said step of indicating the prevalence comprises:
indicating all minority demographic zip codes for a health factor with a prevalence level of at least two mutually exclusive groups.

17. A method for identifying minority health factor disparities within geographic zones as defined in claim 15 wherein:
indicating all minority demographic zip codes for a diabetes health factor with a prevalence level of between 1.5 and 7.5 per cent, 7.51 and 8.6 per cent and above 8.61 per cent.

18. A method for identifying minority health factor disparities within geographic zones as defined in claim 15 and further comprising:
identifying all contiguous zip code zones with a health factor disparity for minorities.

19. A method for identifying minority health factor disparities within geographic zones as defined in claim 15 wherein:
said minority demographic group comprises a subgroup where greater than fifty percent of the subgroup are African American.

20. A method for identifying minority health factor disparities within geographic zones as defined in claim 15 wherein:
said minority demographic group comprises a subgroup where greater than fifty percent of the subgroup are Hispanic.

21. A method for identifying incidences of minority diabetes disparities within zip code zones comprising the steps of:
determining the per cent prevalence of diabetes within a state of the United States for a minority demographic group;
identifying minority demographic group zones by zip code within said state;
determining the per cent prevalence of diabetes of the minority demographic group within the state as a whole;
multiplying the prevalence of said minority demographic group within a zip code by the per cent prevalence of diabetes within the state to determine by estimation the per cent prevalence of minority diabetes by zip codes within the state; and
mapping within the state all zip code zones and identifying all zip code zones within the state with a minority demographic and indicating the prevalence of diabetes within the minority demographic group zip code.

22. A method for identifying incidences of minority diabetes disparities within zip code zones as defined in claim 21 and further comprising the steps of:
identifying the percent estimated prevalence of diabetes within the zip codes within the state.

23. A method for identifying incidences of minority diabetes disparities within zip code zones as defined in claim 22 and further comprising the steps of:
identify the prevalence of diabetes within zip codes for the zip codes with a percent estimated diabetes prevalence of 1.5 to 7.5 percent, 7.51 to 8.6 percent and 8.81 and greater percent.

24. A method for identifying incidences of minority diabetes disparities within zip code zones as defined in claim 22 and further comprising the steps of:
identifying contiguous zip codes within the state with a prevalence of 8.61 percent diabetes and above and whether or the degree of those zip codes identified that are minority.
